(19) United States
(12) Patent Application Publication
(10) Pub. No.: US 2016/0246297 A1
(43) Pub. Date: Aug. 25, 2016

(54) CLOUD-BASED CONTROL SYSTEM FOR UNMANNED AERIAL VEHICLES

(71) Applicant: Siemens Corporation, Iselin, NJ (US)

(72) Inventor: Zhen Song, Plainsboro, NJ (US)

(21) Appl. No.: 15/046,560

(22) Filed: Feb. 18, 2016

Related U.S. Application Data
(60) Provisional application No. 62/120,142, filed on Feb. 24, 2015.

(51) Int. Cl. G05D 1/00; G08G 5/00; B64C 39/02; H04B 7/185; H04L 29/08

(52) U.S. Cl. CPC G05D 1/0022; H04B 7/18506; H04L 67/10; B64C 39/024; G08G 5/006; B64C 2201/126; B64C 2201/146

(57) ABSTRACT

A cloud-based system for controlling the use of unmanned aerial vehicles (UAVs) is used as the communication path between a pilot and his/her UAV, eliminating the direct communication between pilot and vehicle. The cloud-based

UAV control system is configured to include both “control apps” associated with the actual flight of a UAV and “mission-specific apps” that include a set of instructions for a specific mission (i.e., performing energy audit of an industrial complex). The control apps preferably include flight regulations (as provided by the FAA, for example) that are used define “no-fly zones”. Other legitimate government (or non-government) agencies may provide “electric fence” control apps to the cloud-based system, thus preventing UAVs from entering protected areas. The UAVs interacting with the control system are intelligent, able to receive specific mission-based applications from the control system, allowing the UAVs to collect a wide variety of useful information.

### PRIORITY CLAIM

This application claims the benefit of U.S. Provisional Application Ser. No. 62/120,142, filed Feb. 24, 2015, and entitled “SiDrone: Smart Inspection Drones with Apps” which is herein incorporated by reference.

### TECHNICAL FIELD

The present invention relates to a cloud-based control system for unmanned aerial vehicles (UAVs) and, more particularly, to a cloud-based control system that is provided as an interface between pilots and UAVs in a manner that improves the safety of UAVs, while also supporting a number of applications that may be downloaded to a UAV on an as-needed (mission-specific) basis to configure an intelligent UAV.

### BACKGROUND

In recent years, the development of unmanned aerial vehicles (UAVs) has opened many doors to various types of actions that may be performed by these devices. For the most part, however, these UAVs are nothing more that “flying cameras” and have been known to encroach into restricted areas and, at times, interfere with bona fide air traffic.

Various systems have been suggested for using UAVs to perform inspections in areas that are not easily accessible including, for example, performing aerial surveys for wellbore sites, wind turbines and electric utility lines. Again, while UAVs are beneficial in allowing for personnel to be remotely located and “see” a worksite many miles away, these UAVs are often limited in the types of data that can be collected and transmitted back to the pilot.

Problems do remain in the ability to control the flight plan of the UAVs in a manner that avoids restricted airspace. Additionally, the data collected by these UAVs may not be used as efficiently and effectively as possible, based on the owner's analytic capabilities.

### SUMMARY OF INVENTION

The needs remaining in the prior art are addressed by the present invention, which relates to a cloud-based control system for unmanned aerial vehicles (UAVs) and, more particularly, to a cloud-based control system that is provided as an interface between pilots and UAVs in a manner that improves the safety of UAVs, while also supporting a number of applications that may be downloaded to a UAV on an as-needed basis, thus creating an intelligent UAV.

One exemplary embodiment of the present invention takes the form of a system for controlling unmanned aerial vehicles (UAVs) comprising a UAV for collecting data during a flight and a cloud-based control system for interfacing between the UAV and the piloting device. The UAV includes a sensor pack for performing data collection and a processor supporting an operating system for controlling the performance of the UAV by executing instructions embodied in one or more mission-specific application. The cloud-based control system functions to receive commands from the piloting device and transmit commands and applications to the processor within the UAV, the cloud-based control system thus preventing direct communication between the piloting device and the UAV.

Another exemplary embodiment of the present invention is a intelligent unmanned aerial vehicle (UAV) that includes: a sensor pack for performing data collection during a flight, a processor, and a memory containing an operating system for controlling the performance of the UAV, a plurality of control applications and mission-specific applications comprising instructions for data collection by the sensor pack and program instructions executable by the processor to initiate and control the flight of the intelligent UAV based on the plurality of control applications and mission-specific applications. The intelligent UAV also includes a bidirectional wireless link for communicating with a cloud-based UAV control system to download selected control applications and mission-specific applications to the UAV memory, and upload data collected by the UAV to the cloud-based UAV control system.

Yet another embodiment of the present invention comprises a method of controlling an unmanned aerial vehicle (UAV) to perform a specific mission at a cloud-based UAV control system, including the steps of: receiving, at the cloud-based UAV control system, a mission command from a piloting device associated with an identified UAV; processing the mission command at the cloud-based UAV control system to determine applications stored at the control system and required by the identified UAV to perform the mission; downloading the determined applications from the cloud-based UAV control system to the identified UAV; transmitting an initiate flight command from the cloud-based UAV control system to the identified UAV; and receiving, at the cloud-based control system, data collected by the identified UAV during the flight while performing the mission.

Other and further aspects of the present invention will become apparent during the course of the following discussion and by reference to the accompanying drawings.

### BRIEF DESCRIPTION OF DRAWINGS

The exemplary embodiments of the invention can be understood by considering the following detailed description in conjunction with the accompanying drawings, in which:

FIG. 1 is an overview diagram illustrating the use of a cloud-based control system as an interface between a pilot and a UAV;

FIG. 2 is a block diagram of an exemplary cloud-based UAV control system formed in accordance with an embodiment of the present invention;

FIG. 3 is a diagram of an exemplary set of components (sensor packs), flight instruments and processing modules (control applications, mission-specific applications) as installed within an exemplary intelligent UAV formed in accordance with the present invention; and

FIG. 4 is a flowchart of an exemplary method of operating an intelligent UAV using the cloud-based control system of the present invention.

### DESCRIPTION OF EMBODIMENTS

Exemplary embodiments of the invention can be utilized in the control of unmanned aerial vehicles (UAVs), particularly in the form of a cloud-based control that is used as the communication path between a pilot and his/her UAV, eliminating the direct communication between pilot and vehicle. The cloud-based UAV control system is configured to include both “control apps” associated with the actual flight of a UAV and “mission-specific apps” that include a set of instructions for a specific mission (i.e., performing energy audit of an industrial complex). The control apps preferably include flight regulations (as provided by the FAA, for example) that are used define “no-fly zones”. Other legitimate government (or non-government) agencies may provide “electric fence” control apps to the cloud-based system, thus preventing UAVs from entering protected areas. The UAVs interacting with the control system are intelligent, able to receive specific mission-based applications from the control system, allowing the UAVs to collect a wide variety of useful information.

As will be described in detail below, the present invention is directed to a system architecture that may be utilized to control UAVs in a manner that enables the commercialization of these devices and expands their applicability into numerous industrial applications. Indeed, a significant aspect of the present invention is the utilization of a cloud-based UAV control system that is provided as an interface between the “owner” of a UAV (often times referred to herein as the “pilot”) and the vehicle itself. As a result, a pilot cannot intentionally violate governmental regulations or otherwise fly his/her UAV into restricted areas (or collect information from these areas).

In particular, an exemplary cloud-based UAV control system formed in accordance with the present invention includes both “control apps” associated with the actual flight of a UAV and “mission-specific apps” that include a set of instructions for a specific mission (i.e., one or more tasks required to perform a specific request, such as an energy audit of an industrial complex). The control apps preferably include flight regulations (as provided by the FAA, for example) that are used define “no-fly zones”. Other legitimate government (or non-government) agencies may provide “electric fence” control apps to the cloud-based system, thus preventing UAVs from entering protected areas (a common complaint with today's UAVs).

Many different “mission-specific” applications are also resident at the cloud-based system and may be downloaded to a particular UAV (as commanded by the pilot) on a case-by-case basis. It is contemplated that a large number of these applications will be industrial applications associated with energy issues, infrastructure, inspection, audit, and the like. Indeed, in an exemplary embodiment of the present invention, various third parties are able to create and upload mission-specific applications to the control system, creating a type of “App store” of functionalities that may be of interest to other pilots/owners for use in their various UAV-based projects.

Additionally, an exemplary cloud-based UAV control system formed in accordance with the present invention may be further configured to include robust data analytics programs that may be used (under the command control of the pilot) to evaluate the data collected by the UAVs. All data collected by a UAV is communicated directly to the cloud-based control system, where the pilot of the UAV can then command the cloud-based system to perform certain analytics on his behalf to create the desired end product data (e.g., building inspection report, facility energy audit, etc.). For example, robust types of advanced machine learning algorithms may be resident at the cloud-based UAV control system and available for use by the various entities (i.e., pilots) that use the control system to operate their UAVs.

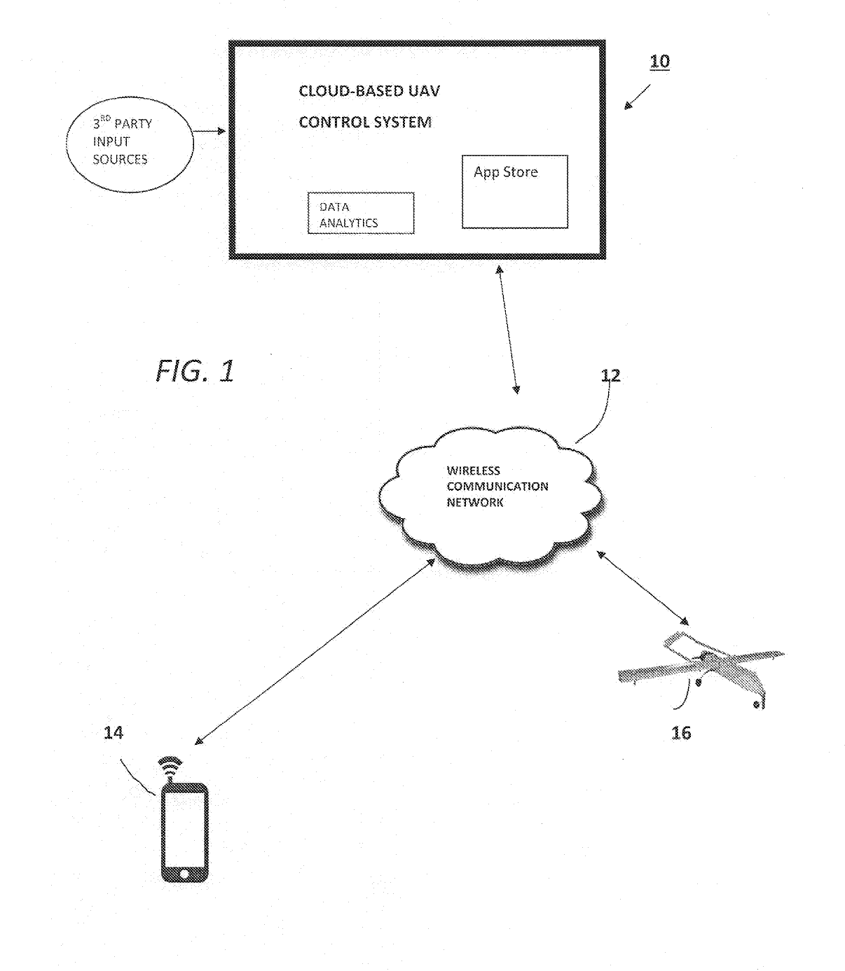

FIG. 1 is a high-level network architecture diagram illustrating the communication flows between a pilot and a UAV, as implemented by a cloud-based control system in accordance with the present invention. In particular, FIG. 1 shows a cloud-based control system 10 that interacts through a wireless communication network 12 with a mobile communication device 14 associated with a UAV pilot. At various times throughout the following discussion, the reference numeral 14 may also be associated with the “pilot” (or the organization owning the UAV), for the sake of convenience. It is to be understood that the actual personnel in charge of flying a UAV will necessarily be providing instructions through a mobile communication device such as that illustrated in FIG. 1. An exemplary UAV 16 is also shown in FIG. 1.

In contrast to current state of the art, the network architecture of the present invention prevents direct communication between pilot 14 and UAV 16. Instead, all communications from pilot 14 are transmitted via wireless network 12 to cloud-based control system 10. In turn, cloud-based control system 10 passes the pilot's commands through wireless network 12 to UAV 16, subject to various rules-based controls that are implemented at cloud-based control system 10 (as discussed below). Thus, to initiate a specific UAV flight, pilot 14 sends a high-level command (via a wireless device, such as a smartphone, for example) to control system 10. Control system 10 then verifies both the pilot and the UAV, as well as the requested mission, sending the commands necessary to initiate and control the actual flight to UAV 16.

As will be described in detail below, it is contemplated that UAV 16 is equipped with various types of cameras and sensors that allow for a wide variety of data to be collected. Indeed, one important use for this type of cloud-based UAV control is associated with industrial applications, where aerial surveys for the purpose of energy audits, equipment inspections, and the like are invaluable. For example, it is contemplated that these UAVs will include IR cameras that create thermal images useful in discovering sources of energy waste, water leakage, etc. Installing gas sensors on a UAV allows for hazardous conditions to be recognized without submitting personnel to harmful situations. Stereo cameras are able to collect data that can thereafter be manipulated to create three-dimensional (3D) models.

Importantly, the UAVs are considered to be “intelligent”, that is, including a processor configured to run various applications installed on the UAV and, importantly, responsive to specific mission-based applications downloaded to the UAV from the cloud-based control system (upon request of the pilot). The ability to download mission-specific applications allows for a UAV to become an “application-specific” device, so to speak; an intelligent UAV able to following instructions and collect appropriate data (and at times, process the data) so that the UAV is able to efficiently function and collect the specific data associated with the defined mission. These applications can be categorized as either “control applications” or “mission-specific applications”. The control applications are associated with an actual flight pattern for a UAV mission, and are considered to relax requirements on the UAV pilots themselves (in terms of knowing various electric fence boundaries) and mitigate concerns from, for example, the FAA and various other legislative groups.

Indeed, a fundamental limitation in the prior art use of UAVs is due to the fact that the pilots—and only the pilots—have direct control over their aerial vehicles. In accordance with the present invention, the pilots now send “high level commands” to the cloud-based UAV control system, which evaluates the command based on information stored in a regulations database at the cloud-based control system (and perhaps other web services). With respect to the “mission-specific applications”, a pilot will be able to select applications (using the App store model, for example) to be downloaded onto his UAV. These applications may include, for example “inspection applications” that utilize specific sensors on the UAV to look for problems at an industrial site (for example, water leaks on roofs, defective solar panels, window insulation issues, etc.). Various “modeling applications” can be downloaded onto a UAV and used in conjunction with stereo camera equipment to generate 3D building models. These are merely illustrative of types of mission-specific applications that may be resident at the cloud-based control system and downloaded to a UAV upon command of the pilot.

A significant aspect of the present invention is the provision of an “App store” model that allows for various organizations (third parties) to upload different applications that may be useful to various entities performing similar UAV-based missions. It is contemplated that control system 10 also functions to regularly check various authentication and verification requirements associated with the UAVs and the pilots, as well as “real-time” information associated with flying conditions, etc.

As shown in FIG. 1, cloud-based control system 10 receives input from sources other than the UAV pilots. In particular, governmental organizations may upload instructions to control system 10. In the United States, for example, the FAA may upload information regarding “no-fly zones” and the DOE may upload GPS-based land survey information. This interface is contemplated as being dynamic, with updates made to the boundaries as necessary. Various other consumer groups and civilians are anticipated as being permitted to upload “electric fence” data to prohibit UAVs from entering areas around their properties.

In further accordance with the present invention, cloud-based control system 10 is itself configured to include advanced data analytics functionality. As will be described in detail below, UAV 16 transmits the data it collects back to control system 10 (instead of pilot 14, as in the prior art). Thus, as soon as the data is received at control system 10, pilot 14 is able to command cloud-based control system 10 to utilize its advance analytic tools to review and study the data and provide the results of the analysis to the pilot (and, perhaps, also transmit the raw data itself to the pilot).

Indeed, the proposed system of the present invention supports a variety of different types of applications useful in interpreting the data collected by the UAVs. For example, a “building modeling” application can establish 3D models using the data collected by UAV-mounted stereo vision cameras and estimate the “R” value of a building's insulations based on IR images collected by a UAV-mounted IR camera. The measured data is transmitted to control system 10, which is then able to build an “energy audit” model. Other types of inspection applications can facilitate pilots to detect defects of different energy assets such as insulation issues on a building envelope, water leaks on a roof, heat recovery problems associated with roof-top units, window insulation issues, solar panel defects, power line overheating issues, etc.

The “control” applications are considered to encompass the flight plan rules as established by the FAA (for example) and other authorities. In operation, pilot 14 sends a high level command to control system 10, requires that UAV 16 perform an aerial energy audit of a specific facility (as identified by its GPS coordinates, perhaps). The control applications at control system 10 will pass this command onto UAV 16 as long as UAV does not have to cross any pre-defined “no-fly zone” to accomplish this mission. If control system 10 cannot grant permission for this flight, pilot 14 will be notified.

With thus understanding of the overall network architecture of the inventive cloud-based UAV control system, the various details associated with the configuration and utilization of this system will now be described in detail.

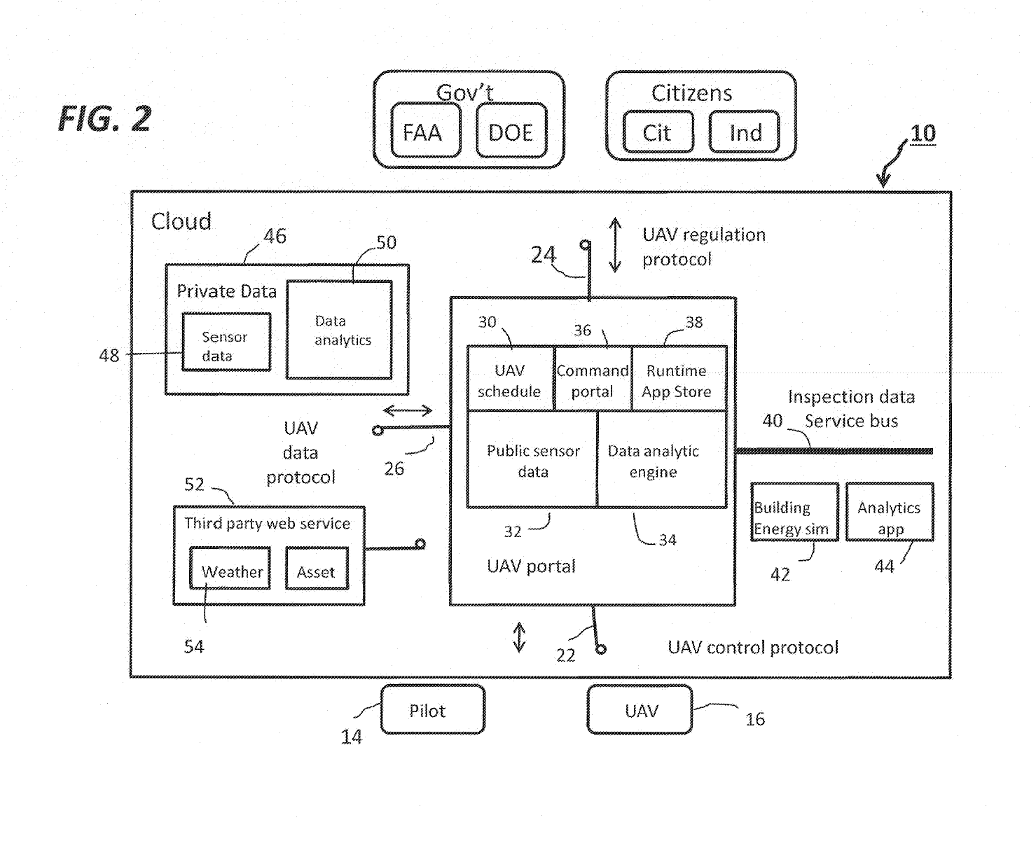

FIG. 2 contains a diagram of an exemplary architecture configuration for cloud-based control system 10. As shown, control system 10 includes a UAV portal component 20 that is able to communicate with pilot 14 and UAV 16 via a UAV control protocol 22. Various government entities (and, possibly, private citizens) associated with providing control applications are shown as communicating with component 20 via a UAV regulation protocol 24. A government entity may also desire to upload systems and software associated with UAV maintenance schedules, pilot logs, and the like through regulation protocol 24. Various third party suppliers of applications (typically, mission-specific applications) for use by UAVs are shown as communicating with UAV portal component 20 via a UAV data protocol 26. Other information that may be uploaded through data protocol 26 is contemplated to include (but not be limited to) real-time weather information.

In the particular configuration of cloud-based UAV control system as shown in FIG. 2, UAV portal component 20 is shown as including a UAV schedule database 30, a public sensor database 32, a data analytic engine 34, a command portal 36, and (as mentioned above) a runtime app store 38. Specific elements that communicate with UAV portal component 20 along an inspection data service bus 40 are shown as including a building energy simulator application 42 and an analytics application 44.

Also shown in FIG. 2 is a private data module 46 that is located within cloud-based control system 10, but is protected via a firewall (or similar method) from being accessible by everyone utilizing the control system. It is contemplated that various subscribers to the system will each have private data partitions for storage and analysis of data collected by their UAVs. Here, private data module 46 is seen as including a sensor database 48 (perhaps for storing raw data collected by the owner's UAV) and a data analytics processor 50, where processor 50 may include propriety analysis algorithms (for example) that only pilot 14 is able to utilize in the analysis of the data collected by UAV 16.

The specifics of cloud-based UAV control system 10 as shown in FIG. 2 are considered to be exemplary only; many other modules, subsystems and applications may be incorporated within this platform. Indeed, it is considered that those skilled in the art can appreciate the various details involved in providing communication between control system 10, pilots 14 and UAVs 16, as well as the possibilities for providing cloud-based analytics of the data collected by the UAVs.

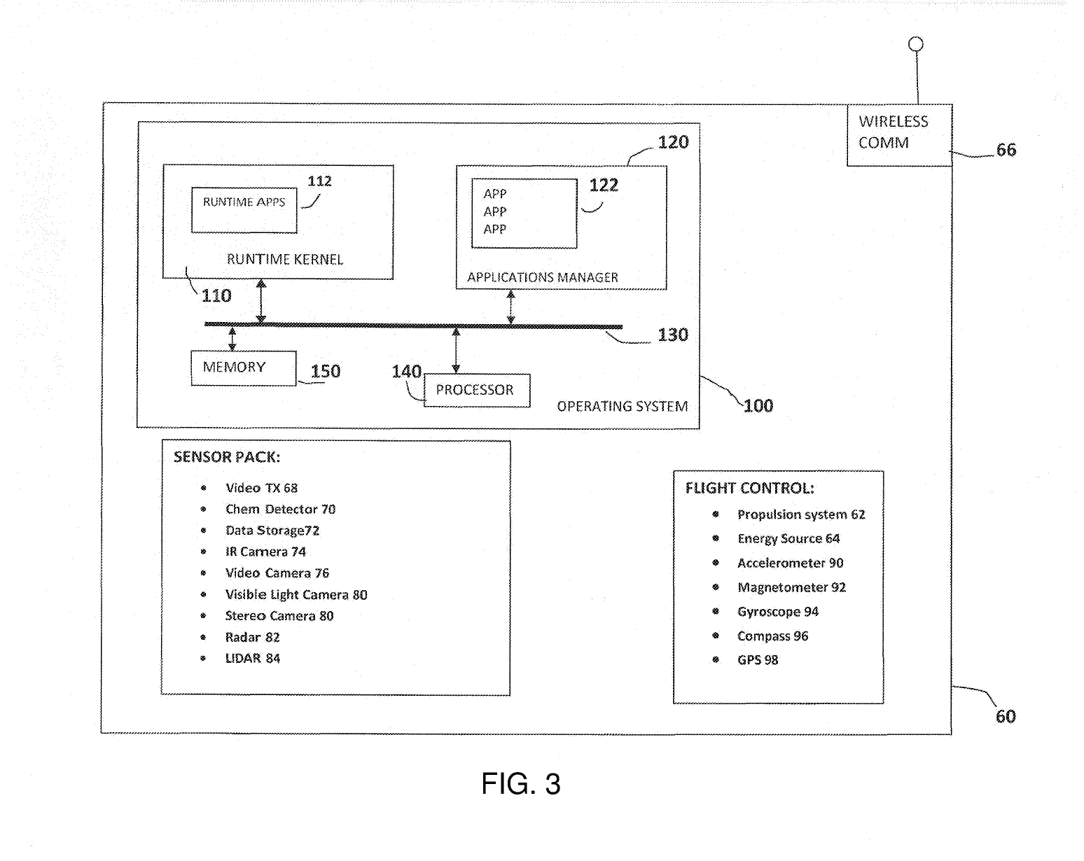

FIG. 3 is a block diagram 60 representing an exemplary set of components contained within UAV 16. In some examples, UAV 16 may be provided as a fixed wing aircraft. In some other examples, UAV 16 may be provided as a rotary wing aircraft.

In the example of FIG. 3, UAV components 60 are shown as including flight-related elements such as a propulsion system 62 and an energy source 64. Example propulsion systems 62 include one or more combustion engines that drive one or more propellers or blades, and one or more electric machines that drive one or more propellers or blades. It is contemplated, however, that UAV 16 can be propelled by any appropriate propulsion system, or combination of propulsion systems. Example energy sources 64 can include fuel, e.g., gasoline, and/or an energy storage device, e.g., a battery, a capacitor. In some examples, the energy source 64 includes one or more fuel cells. In some examples, the energy source includes one or more solar panels. Additional components for controlling the actual flight of UAV 16 may include an accelerometer component 90, a magnetometer component 92, a gyroscope component 94, a compass component 96, and a global positioning system (GPS) component 98.

In the depicted example, UAV 16 further includes a wireless communication module 66 that provides a bi-directional communication link with cloud-based control system 10 though wireless network 12 (i.e., receiving commands and downloaded apps from system 10, and transmitting data and survey information to control system 10). In most configurations, UAV 16 also includes a number of sensors, shown in this exemplary set as a sensor pack comprising a video transmitting (Tx) component 68, a chemical detection component 70, a data storage component 72, an IR camera component 74, a video camera component 76, a visible light camera component 78, a stereoscopic camera component 80, a radar component 82, and a light detection and ranging (LIDAR) component 84. The components depicted in FIG. 3, and described herein, are example components, and it is appreciated that UAV 16 can include more or fewer components.

In accordance with the inventive concepts of creating an “intelligent” UAV, FIG. 3 illustrates that UAV 16 is further configured to include an operating system 100 including a runtime kernel 110 utilized to manage any mission-specific runtime apps 112 that are downloaded to UAV 16 from the control system 10 immediately prior to flight. Operating system 100 also includes in this case an applications manager 120 that oversees the various pre-installed applications 122 resident in UAV 16. An exemplary pre-installed application may include, for example, instructions on emergency landing in the event of loss of communication with cloud-based control system 10. In the particular configuration as shown in FIG. 3, operating system 100 also includes a communication bus 130 for providing communication between runtime kernel 110 and applications manager 120, as well as a memory element 130 for storing the executable instructions associated with the various applications utilized by UAV 16 and a processor 140 that converts these executable instructions into instructions used by the sensors to actually perform the data collection. The collected data may be stored in memory element 130 before it is communicated to the cloud-based control system.

Thus, unlike many of the prior art UAVs, an intelligent UAV formed in accordance with the present invention is processor-based and able to accept and implement various mission-specific applications selected by the pilot (and transmitted from the control system to the UAV). In this manner, the same UAV may be programmed one day to perform an energy audit on an industrial site, and then programmed another day to perform a search for wellbore sites. By including a sensor pack with a variety of different instrumentation within the UAV, it is possible to change the functionality of the UAV to suit the needs of the pilot (while always maintaining the cloud-based system as an intermediary between the pilot and the UAV).

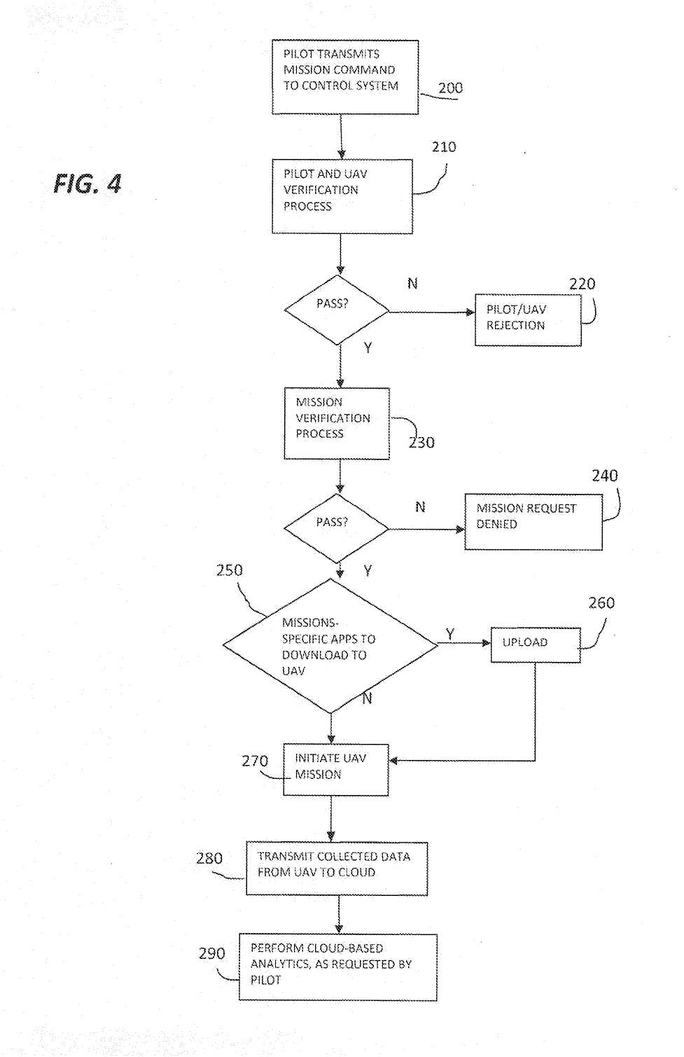

FIG. 4 is a flowchart illustrating an exemplary process for executing a specific mission utilizing the cloud-based UAV control system of the present invention. The process begins with the pilot sending a mission request to control system 10 (shown as step 200). This mission request is a relatively high-level command, identifying the specific UAV to be utilized, the location to be surveyed and the purpose of the mission (i.e., “energy audit of Building A”).

Upon receipt of the request, control system 10 performs a number of checks (step 210) to verify the credentials of the pilot and the identified UAV (including, for example the maintenance records of the UAV). If there is a problem with either the pilot or the UAV, a “rejection” message is returned to the pilot (step 220), and the mission is denied. Presuming that the pilot and UAV are both qualified, control system 10 also performs a check of the specifics of the mission (i.e., verifying that the area is not subject to any no-fly zone or electric fence boundaries), shown as step 230. Again, if a geographic area denial is presented, the pilot is sent a “mission denied” message (step 240), otherwise control system 10 continues by reviewing the actual processes required by the defined mission (step 250).

After this review, control system 10 determines if there are any specific applications that need to be uploaded to the UAV in order for it to collect the proper data (step 260). And, if so, the required applications are uploaded to UAV 16, creating an “intelligent” UAV for that specific mission, and the actual flight is initiated (step 270).

During the UAV flight, and subsequent thereto, the data collected by the UAV is transmitted to control system 10 (shown as step 280). At this point, the pilot can request control system 10 (step 290) to perform specific analytics on the collected data and transmit the results to the pilot.

It is contemplated that various industrial applications, such as energy audit criteria, 3D building modeling, and the like, will be available in the “app store” at the control system, where a pilot may request that a specific application be downloaded onto the UAV under his control. In this manner, a UAV can be re-programmed again and again to perform different industrial tasks for each flight. Advantageously, the pilot need not be burdened with creating a specific instruction set for use by the UAV, since the readily-available applications are accessible at the cloud-based control system.

Importantly, the capabilities of utilizing UAVs in these various situations is fully realized in accordance with the present invention by preventing direct communication between the pilot and the UAV. The insertion of the cloud-based control system in the path between the pilot and UAV allows for regulated, internet-connected UAVs that are constantly monitoring by one or more of the control applications contained within the cloud-based control system. The FAA and other governmental agencies are able to define forbidden zones and provide GPS coordinates for “electric fences” that will prevent these industrial UAVs from entering forbidden air space. Additionally, in a preferred embodiment of the present invention, a UAV can be pre-programmed to immediately land if the communication link to the cloud-based control system is lost.

Summarizing, the present invention as described above provides a cloud-based control system that will drastically improve and increase the potential for use UAVs in a wide variety of industrial settings. Today's energy asset inspection standards and building energy modeling processes are labor intensive manual work. Current class G drones are “flying cameras” without system design or data analysis capabilities necessary for commercial energy inspections. Indeed, today's drones are not effective for inspections, and impose many safety, security, and privacy concerns. The utilization of an intelligent UAV (having specific applications downloaded prior to flight) in accordance with the present invention creates an industrial inspection system with great potential to address and overcome many of today's concerns.

While reference to an exemplary cloud-based UAV control system is anticipated to be implemented by software modules executed by the processor, it is also to be understood that exemplary embodiments of the invention may be implemented in various forms of hardware, software, firmware, special purpose processors, or a combination thereof. Preferably, aspects of the invention embodiments are implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. In addition, various other peripheral devices may be connected to the computer/controller platform.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function. The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

It is also to be understood that, because some of the constituent system components and method steps depicted in the accompanying figures are preferably implemented in software, the actual connections between the system components (or the process steps) may differ depending upon the manner in which the exemplary embodiments are programmed. Specifically, any of the computer platforms or devices may be interconnected using any existing or later-discovered networking technology and may also all be connected through a lager network system, such as a corporate network, metropolitan network or a global network, such as the Internet.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical or electrical connections or couplings.

Although various embodiments that incorporate the teachings of the present invention have been shown and described in detail herein, those skilled in the art can readily devise many other varied embodiments that still incorporate these teachings. The invention is not limited in its application to the exemplary embodiment details of industrial surveillance applications (such as for energy audits, building inspections and the like) and the arrangement of components set forth in the description or illustrated in the drawings. The invention is capable of other embodiments and of being practiced or of being carried out in various ways.

Any and all articles, patents, patent applications, and other publications that have been cited in this disclosure are incorporated herein by reference in their respective entirety.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow.

That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an an does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

Of course, those of skill in the art will recognize that, unless specifically indicated or required by the sequence of operations, certain steps in the processes described above may be omitted, performed concurrently or sequentially, or performed in a different order.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A system for controlling unmanned aerial vehicles (UAVs) comprising
a UAV for collecting data during a flight, the UAV including a sensor pack for performing data collection and a processor supporting an operating system for controlling the performance of the UAV by executing instructions embodied in one or more mission-specific; and
a cloud-based control system for interfacing between a piloting device and the UAV, the cloud-based control system receiving commands from the piloting device and transmitting commands and applications to the UAV processor, the cloud-based control system preventing direct communication between the piloting device and the UAV.

2. The system as defined in claim 1 wherein the cloud-based control system comprises
a processor component including a data processing element for evaluating data received from UAVs and a memory element;
control applications modules associated with flight-control for UAVs, stored within the memory element; and
mission-specific applications modules for UAVs, stored within the memory element.

3. The system as defined in claim 1 wherein the cloud-based control system comprises a plurality of protocol interfaces for communicating with UAVs, piloting devices and third parties.

4. The system as defined in claim 3 wherein piloting devices and UAVs communicate with the cloud-based UAV control system through a UAV control protocol.

5. The system as defined in claim 3 wherein government agencies communicate with the cloud-based UAV control system through a UAV regulation protocol.

6. The system as defined in claim 5 wherein government agencies upload control applications to the cloud-based control system that define no-fly zones for UAVs.

7. The system as defined in claim 3 wherein one or more third parties communicate with the cloud-based UAV control system through a UAV data protocol.

8. The system as defined in claim 1 wherein the cloud-based control system further comprises a private data partition for storing data accessible only by authenticated personnel.

9. The system as defined in claim 8 wherein the private data partition includes a database of sensor readings and a private data analytics engine for use by authenticated personnel in analyzing the sensor readings.

10. A intelligent unmanned aerial vehicle (UAV) comprising
a sensor pack for performing data collection during a flight;
a processor;
a memory containing
an operating system for controlling the performance of the UAV;
a plurality of control applications and mission-specific applications comprising instructions for data collection by the sensor pack; and
program instructions executable by the processor to initiate and control the flight of the intelligent UAV based on the plurality of control applications and mission-specific applications; and
a bidirectional wireless link for communicating with a cloud-based UAV control system, the bidirectional link for downloading selected control applications and mission-specific applications to the UAV memory, and uploading data collected by the UAV to the cloud-based UAV control system.

11. The intelligent UAV as defined in claim 10 wherein the operating system comprises
a runtime kernel for executing mission-specific applications downloaded to a UAV at runtime to program the UAV for a specific flight purpose; and
an application manager for controlling the utilization of one or more pre-installed control applications and mission-specific applications resident in the UAV; and

[symbol]

12. The intelligent UAV as defined in claim 10, wherein the sensor pack includes one or more sensors selected from the group consisting of: an IR camera, a stereo camera, video recorder and a chemical/gas sensor.

13. The intelligent UAV as defined in claim 10 wherein the operating system further comprises a failsafe mechanism for landing the UAV upon failure of the bidirectional wireless communication link.

14. A method of controlling an unmanned aerial vehicle (UAV) to perform a specific mission at a cloud-based UAV control system, the method including the steps of:
receiving, at the cloud-based UAV control system, a mission command from a piloting device associated with an identified UAV;
processing the mission command at the cloud-based UAV control system to determine applications stored at the control system and required by the identified UAV to perform the mission;
downloading the determined applications from the cloud-based UAV control system to the identified UAV;
transmitting an initiate flight command from the cloud-based UAV control system to the identified UAV; and
receiving, at the cloud-based control system, data collected by the identified UAV during the flight while performing the mission.

15. The method of claim 14 wherein the processing step includes determining both control applications and mission-specific applications required by the identified UAV to perform the mission.

16. The method of claim 14 further comprising the step of
at the cloud-based control system, authenticating the piloting device to perform UAV-based missions prior to processing the mission command.

17. The method of claim 14 further comprising the step of
at the cloud-based control system, authenticating the identified UAV prior to processing the mission command.

18. The method of claim 14 further comprising the step of:
at the cloud-based control system, processing a plurality of control applications to determine if the mission command violates any restricted air spaces.

19. The method of claim 14 further comprising the step of:
at the cloud-based control system, analyzing the data collected by the identified UAV using data processing analytics resident at the cloud-based UAV control system to generate a set of results information.

20. The method of claim 19 further comprising the step of:
transmitting the generated results information from the cloud-based UAV control system to the piloting device.
